(19) United States
(12) Patent Application Publication
(10) Pub. No.: US 2012/0182093 A1
(43) Pub. Date: Jul. 19, 2012

(54) MICROWAVE FILTER

(75) Inventors: Hans-Olof Vickes, Saro (SE); Simon Kristiansson, Bohus-Bjorko (SE)

(73) Assignee: SAAB AB, Linkoping (SE)

(21) Appl. No.: 13/384,341

(22) PCT Filed: Jul. 14, 2009
(86) PCT No.: PCT/SE2009/050899

§ 371 Date: Mar. 22, 2012

(51) Int. Cl. H01P 1/203

(52) U.S. Cl. 333/204

(57) ABSTRACT

A filter unit and a corresponding printed circuit board. The filter unit and the printed circuit board have been equipped with modified end portions being matched such that a number of filter units can be used on the printed circuit board without changing the printed circuit board.

### TECHNICAL FIELD

The present invention relates to a microwave filter and a printed circuit board.

### BACKGROUND

Microwave filters are today often realized as microstrip filters integrated in the layout of Printed Circuit Boards (PCB). The PCB is in the form of a layered structure with a ground plane on one side of a dielectric substrate and the printed circuit is in the form of microstrips on the other side of the substrate. The PCB comprises a number of components and filters that together gives a desired performance of the PCB. A drawback with this solution is that when the filter characteristics have to be changed, the complete PCB layout must be changed in order to match the filter and the PCB to avoid discontinuities. Hence, in prior art the PCB is dependent on filter specifics.

There is thus a need for an improved PCB and microwave filter unit in a strip line configuration allowing the PCB to be non filter specific and where a standard PCB without special treatment consequently can be used for different filter properties.

### SUMMARY

The object of the invention is to reduce at least some of the mentioned deficiencies with the prior art solutions and to provide an improved microwave filter and a corresponding method where the microwave filter unit is realized in a strip line configuration not being dependent on a ground plane of the PCB to which the filter is mounted, allowing the PCB to be non filter specific and where a standard PCB without special treatment can be used.

The invention refers to a microwave filter unit according to claim 1 and a printed circuit board according to claim 2.

In the coming multifunction radar systems with capability of beam steering (AESA=Active Electrical Steered Antenna), the invention finds its place specifically. In general the invention is suitable for implementation on printed circuit boards for microwave frequencies.

The present invention has the benefit of solution comprising a printed circuit board that can be used with different filter units with different filter characteristics, which means that the same printed circuit board can be used for different purposes by choosing suitable filter units. The filter units can thus be designed operating at different frequencies and requiring exactly the same area on the circuit board. The circuit board thus becomes non filter specific.

Additional benefits are that the invention gives a low-loss and broadband-design of coupling RF microstrip mode up to stripline mode, and vice versa, at RF ports, and that frequency selectivity is done at stripline level.

Yet further advantages are that in-house design using regular tools is possible and that a low cost component easily can be mounted on a circuit board, only requiring so called sight marks.

### BRIEF DESCRIPTION OF THE DRAWINGS

The invention will below be described in connection to a number of drawings in which:

FIG. 1 schematically shows a top view of a printed circuit board and a filter according to the invention;

FIG. 2 schematically shows a side view along line A-A in FIG. 1;

FIG. 3a schematically shows a side view of a filter unit along line A-A in FIG. 1;

FIG. 3b schematically shows a cross-sectional side view of a printed circuit board along line A-A in FIG. 1;

FIG. 4a schematically shows a top view of a printed circuit board according to the invention;

FIG. 4b schematically shows an enlarged portion of the top view of the printed circuit board in FIG. 4a;

FIG. 5a schematically shows a bottom view of a filter unit according to the invention;

FIG. 5b schematically shows an enlarged portion of a bottom view of the filter unit in FIG. 5a, and in which;

FIG. 6 schematically teaches a general coplanar waveguide geometry with lower ground plane (CPWG)

### DETAILED DESCRIPTION

In the drawings an orthogonal system has been depicted with arrows X, Y and Z for facilitating the description of the invention. The three directions referred to are; a longitudinal direction X (length), a lateral direction Y (width) and a thickness direction Z.

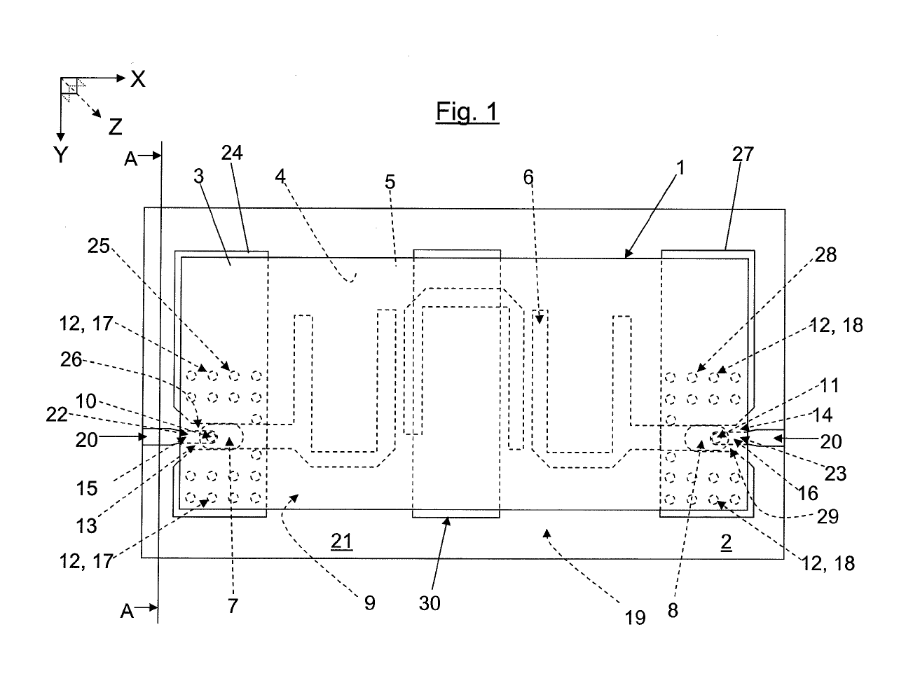

Common reference numbers are recurring in FIGS. 1-5.

The printed circuit board 2 has an extension in the X-Y-plane and is layered in the thickness direction Z. The filter unit 1 has an extension in the X-Y-plane and is layered in the thickness direction Z.

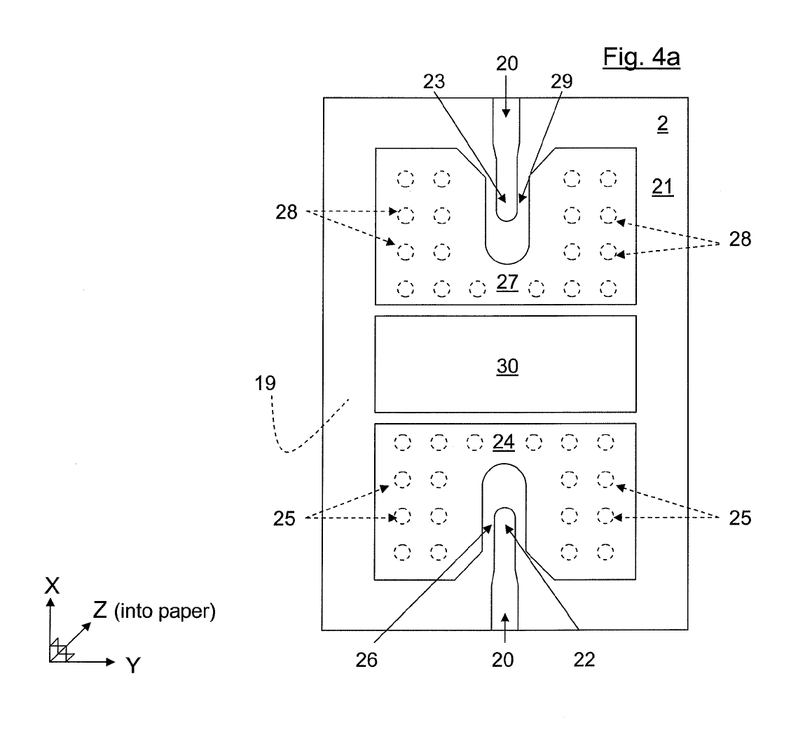

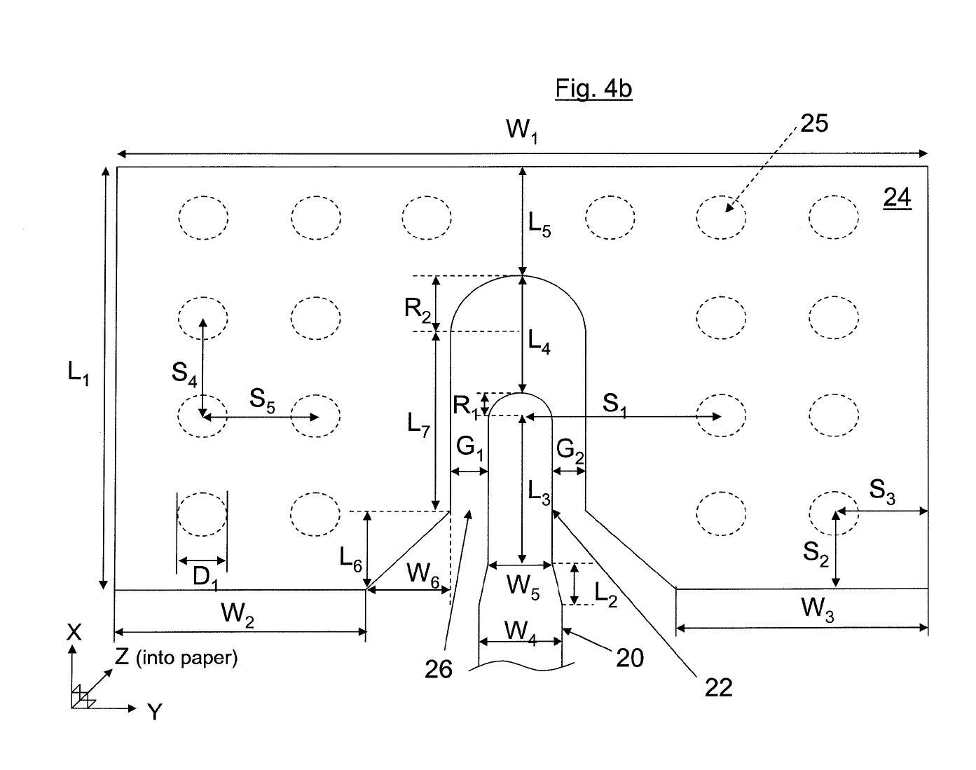

FIG. 1 schematically shows a top view of a printed circuit board and a filter according to the invention. FIG. 1 shows a stripline microwave filter unit 1 attached galvanic to a printed circuit board 2 comprising a microstrip structure, followed by a transition to co-planar waveguide structure with lower ground plane, illustrated more clearly in FIG. 4a and FIG. 4b. The filter unit 1 comprises a layered structure comprising a first ground plane 3, a second ground plane 4 and a dielectric first substrate 5 therebetween. The filter unit 1 also comprises a first conductor structure 6 embedded in the first substrate 5. The first conductor structure 6 has a first end portion 7 and a second end portion 8. The first end portion 7 is connected to a bottom outside 9 of the filter unit 1 by a first connector 10 and the second end portion 8 is connected to the bottom outside 9 of the filter unit 1 by a second connector 11. The first ground plane 3 is connected to the second ground plane 4 by a third connector 12.

FIG. 1 shows that the second ground plane 4 is positioned on the bottom outside 9 of the filter unit 1 and that the second ground plane 4 has a first notch 13 in connection to the first connector 10 revealing the first substrate 5 and that the second ground plane 4 has a second notch 14 in connection to the second connector 11 revealing the first substrate 5. The first connector 10 is connected, via the first connector 10, to a first connector pad 15 positioned in the first notch 13 on the bottom outside 9 of the first substrate 5. The second connector 11 is connected, via the second connector 11, to a second connector pad 16 positioned in the second notch 14 on the bottom outside of the first substrate 5. The third connector 12 comprises fourth connectors 17 electromagnetic coupled to the first connector 10 and fifth connectors 18 electromagnetic coupled to the second connector 11.

The first end portion 7, the first connector 10, the first connector pad 15, the fourth connectors 17 and the first notch 13 are positioned in relation to each other such that a predetermined impedance is essentially obtained for the transmission of a signal from the first connector pad 15 to the first end portion 7.

The second end portion 8, the second connector 11, the second connector pad 16, the fifth connectors 18 and the second notch 14 are positioned in relation to each other such that a predetermined impedance is essentially obtained for the transmission of a signal from the second end portion 8 to the second connector pad 16.

FIG. 1 shows that the printed circuit board 2 comprises a third ground plane 19, a second conductor structure 20 and a dielectric second substrate 21 therebetween. The second conductor structure 20 comprises a third end portion 22 and a fourth end portion 23. The third end portion 22 and the fourth end portion 23 are positioned relative each other such that the first connector pad 15 of the filter unit 1 can be attached to the third end portion 22 and such that the second connector pad 16 can be attached to the fourth end portion 23. The printed circuit board 2 comprises a first ground portion 24 positioned on the same side of the second substrate 21 as the second conductor structure 20 and is connected to the third ground plane 19 by a first ground connector 25. The first ground portion 24 comprises a third notch 26 positioned such that the third end portion 22 is positioned within the third notch 26.

The printed circuit board 2 comprises a second ground portion 27 positioned on the same side of the second substrate 21 as the second conductor structure 20 and is connected to the third ground plane 19 by a second ground connector 28. The second ground portion 27 comprises a fourth notch 29 positioned such that the fourth end portion 23 is positioned within the fourth notch 29.

The first ground portion 24, the third notch 26, the third end portion 22 and the first ground connector 25 are being positioned in relation to each other such that a predetermined impedance is essentially obtained in the third end portion 22 for the transmission of a signal from the second conductor structure 20 to the filter unit 1.

The second ground portion 27, the fourth notch 29, the fourth end portion 23 and the second ground connector 28 are being positioned in relation to each other such that a predetermined impedance is essentially obtained in the fourth end portion 23 for the transmission of a signal from the filter unit 1 to the second conductor structure 20.

When the filter unit 1 is attached to the printed circuit board 2, the first ground portion 24 and the second ground portion 27 is galvanic connected to the second ground plane 4 of the filter unit 1 and the first connector pad 15 of the filter unit 1 is galvanic connected to the third end portion 22 and the second connector pad 16 is galvanic connected to the fourth end portion 23. Here, “galvanic connected” could be achieved by soldering or any other suitable attachment means for galvanic connection.

The ground planes, the conductor structures, the connectors, connector pads and ground portions are all made of electrically conducting materials such as metals.

In another example, the first ground portion 24 and/or the second ground portion 27 may comprise two or more parts being arranged in relation to each other in such a way that a good galvanic contact is established with the second ground plane 4 of the filter unit 1 and in such a way that the a predetermined impedance is essentially obtained in the third end portion 22 for the transmission of a signal from the second conductor structure 20 to the filter unit and in such a way that a predetermined impedance is essentially obtained in the fourth end portion 23 for the transmission of a signal from the filter unit 1 to the second conductor structure 20.

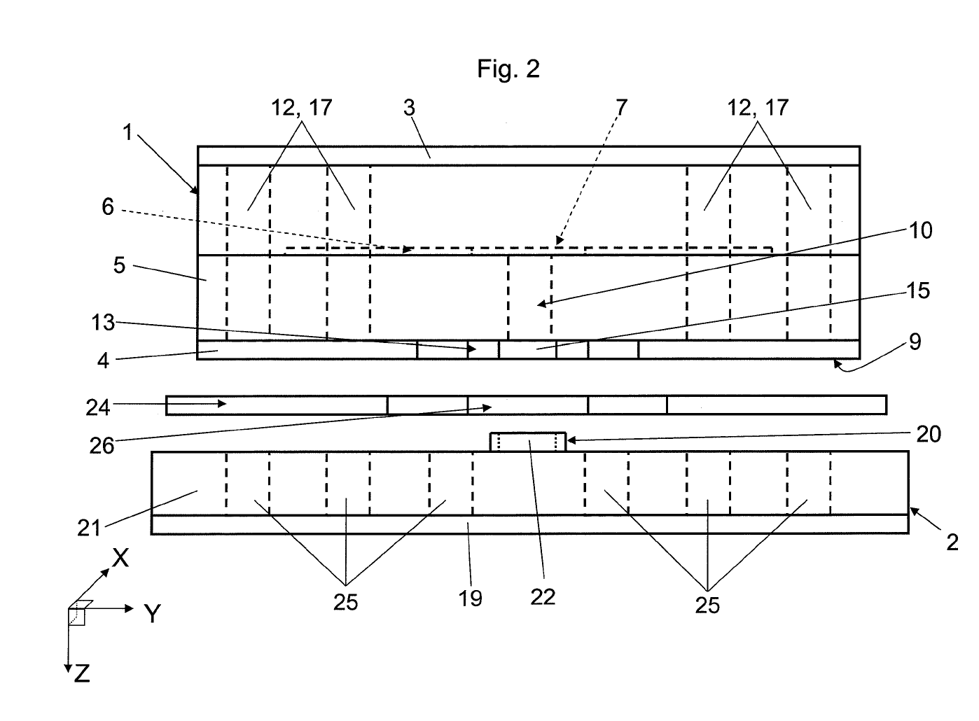

FIG. 2 schematically shows a side view along line A-A in FIG. 1. FIG. 2 shows the filter unit 1, the first and second ground portions 24, 27 and the printed circuit board 2 separated from each other, i.e. before assembly. It should be noted that the first and second ground portions 24, 27 advantageously is a part of the printed circuit board 2 and not separate units.

The benefit lies in that the first and second ground portions 24, 27 can be made during manufacturing of the printed circuit board, for example by etching.

The first and second ground connectors 25, 28 and the third, fourth and fifth connectors 12, 17, 18 could all be so called vias, i.e. plated holes that provide electrical connections.

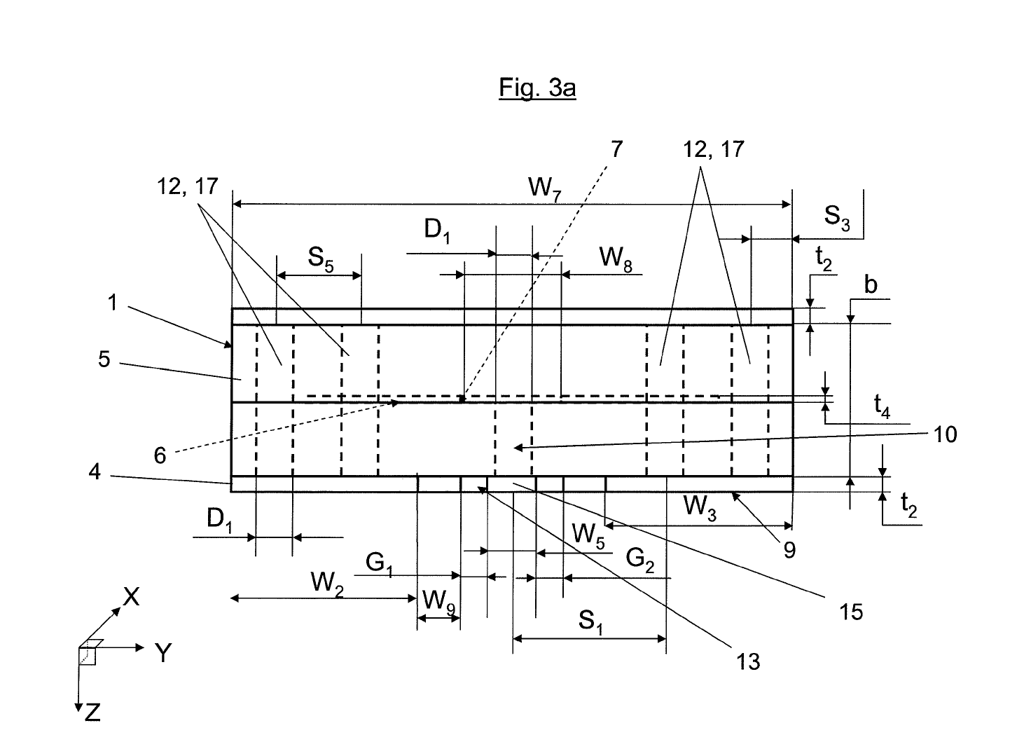

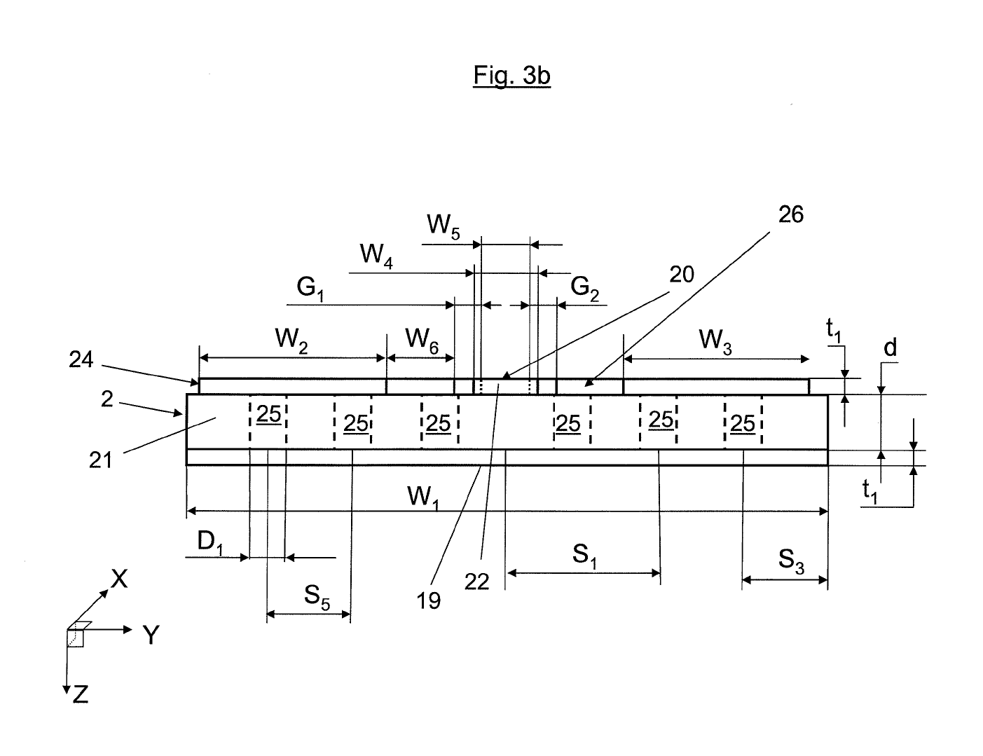

FIG. 3a schematically shows that the first conductive structure comprises a flat strip of metal which is embedded in an insulating material and sandwiched between two parallel ground planes. The insulating material forms the dielectric substrate. The width w8 of the strip, the thickness b of the substrate and the relative permittivity of the substrate determine the characteristic impedance of the strip which is a transmission line. In the filter unit, the first conductive structure comprises a number of strips being electromagnetically connected. The interrelationship between these parts forms the filter characteristics. The first conductive structure does not have to be equally spaced between the ground planes. In the general case, the dielectric material may be of different characteristics and thickness above and below the first conductive structure.

In one example of the invention, the manufacture of the filter unit is done by putting together two parts, each part comprising a ground plane and a dielectric substrate. One of the parts comprises the first conductive structure and when the two parts are put together, the above described sandwich structure of the filter unit is achieved. The first conductive structure can be etched on the surface on one of the parts or may be a separate structure that is sandwiched between the two substrates. The method described has been proven to be fast and cheap.

In another example, both parts may each comprise a first conductive structure which are matched to each other when the parts are put together. In both examples, the parts can be attached to each other by attachment means such as glue, but may also be attached to each other by the surfaces of the substrates bonding to each other.

The microstrip in the printed circuit board is a type of electrical transmission line which can be fabricated using printed circuit board technology, and is used to convey microwave-frequency signals. It comprises the second conducting strip separated from the third ground plane by the dielectric layer of the second substrate. Microwave components are used in radars, antennas, couplers, filters, power dividers etc. and can be formed from a microstrip. The microstrip comprises a pattern of metallization on the substrate. Microstrip is thus much less expensive than traditional waveguide technology, as well as being far lighter and more compact.

FIG. 3a schematically shows a side view of a filter unit along line A-A in FIG. 1. FIG. 3b schematically shows a cross-sectional side view of a printed circuit board along line A-A in FIG. 1.

FIG. 3a is identical to the filter unit in FIG. 2 and FIG. 3b is identical to the printed circuit board shown in FIG. 2 but with the first and second ground portions 24, 27 being part of the printed circuit board 2. In addition to the reference numbers in FIG. 2, FIGS. 3a, 3b, 4b and 5b show a number of reference numbers regarding dimensions of various parts of the filter unit 1.

FIG. 4a schematically shows a top view of a printed circuit board according to the invention. In FIG. 4a a support portion 30 is positioned between the first ground portion 24 and the second ground portion 27 for support of the filter unit 1 on the printed circuit board 2. The support portion could also be connected to the third ground plane 19 via connectors for additional conduction between the third ground plane 19 and the filter unit 1 via galvanic contact with the second ground plane 4.

FIG. 4b schematically shows an enlarged portion of the top view of the printed circuit board in FIG. 4a.

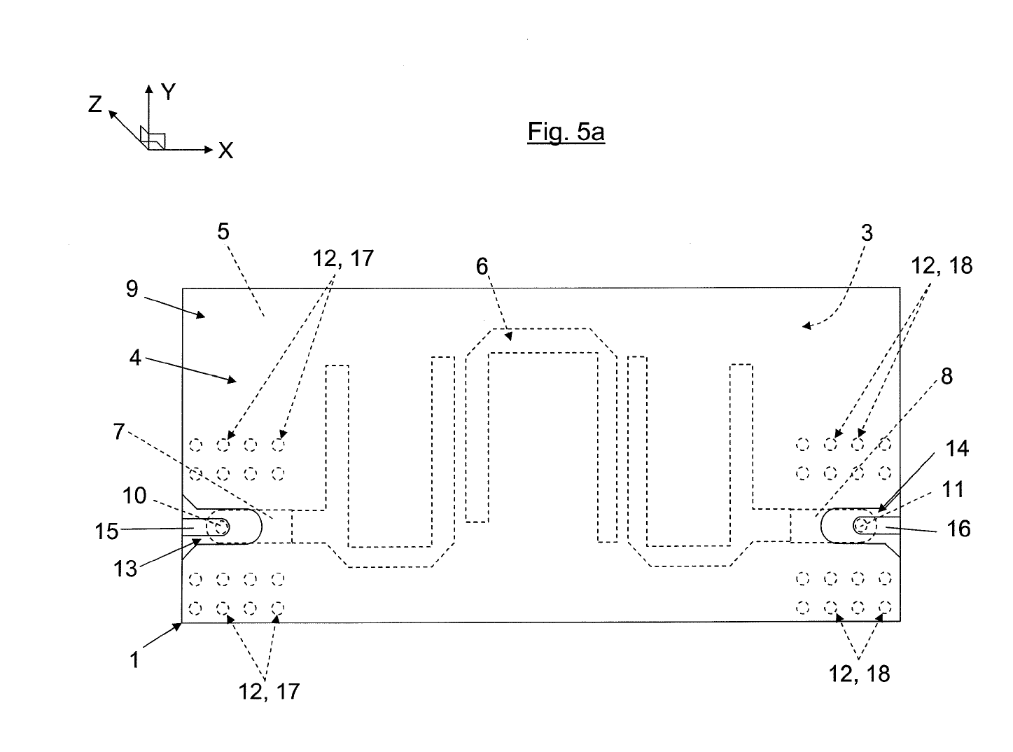

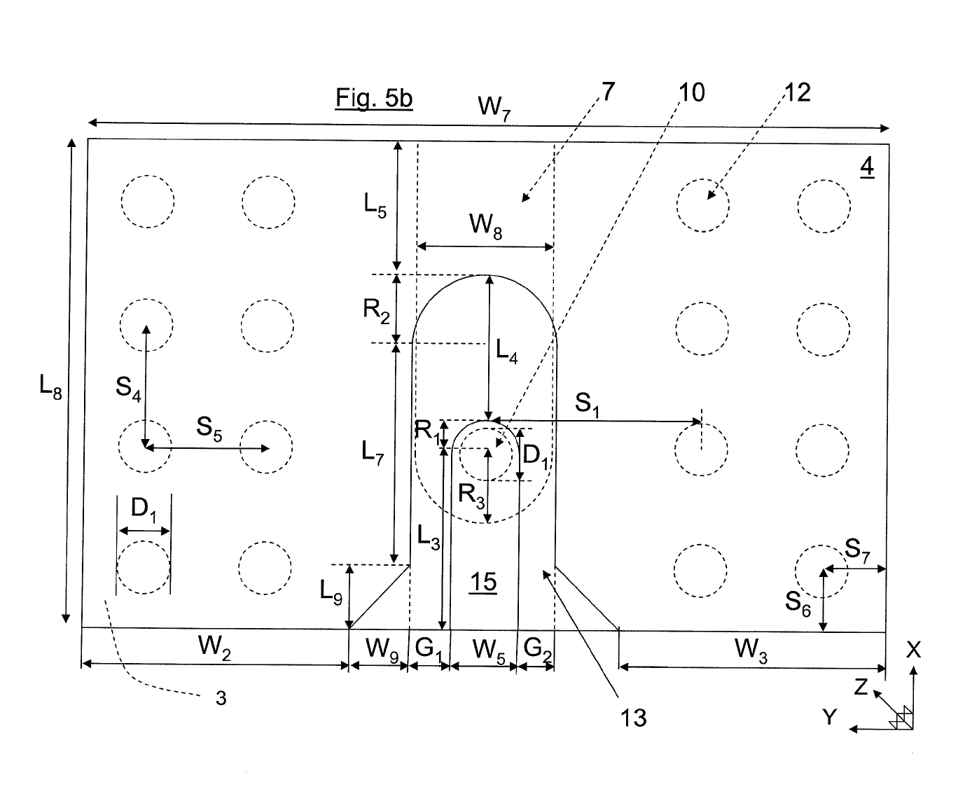

FIG. 5a schematically shows a bottom view of a filter unit according to the invention.

FIG. 5b schematically shows an enlarged portion of a bottom view of the filter unit in FIG. 5a.

The invention makes use of two well defined structures, a printed circuit board 2 and a filter unit 1. As soon as a microwave material is selected, its dielectric constant ∈ᵣ and thickness h, dictates certain dimensions as e.g. conductor widths and gaps. It is therefore advisable, in cases where it is possible, to show closed form expressions for the impedance Z of a transmission line or conductor. It must be understood that there does not exist closed form expressions for all dimensions needed in this invention, so numerical tools are used in such cases.

The printed circuit board 2 and the first ground portion 24 are seamless integrated to one unit, shown in FIGS. 3b, 4a and 4b. This results in a microstrip line structure followed by a transition to a variation of a coplanar waveguide geometry with lower ground plane, hereinafter called CPWG.

Microstrip: The microstrip line geometry is partly illustrated in FIGS. 4a and 4b and its cross section is illustrated in FIG. 3b. In general we assume a substrate thickness of d and a strip conductor of width w4 and thickness t1 and a dielectric constant ∈ᵣ. Thus, the characteristic impedance can be calculated as

$$\begin{matrix}{Z}_{0} = \{ \frac{60}{\sqrt{{ɛ}_{r , eff}}} ln ( \frac{8 d}{w 4} + \frac{w 4}{4 d} ) , … for \cdot \frac{w 4}{d} \leq 1 \\ {Z}_{0} = \{ \frac{120 π}{\sqrt{{ɛ}_{r , eff}} [ \frac{w 4}{d} + 1.393 + 0.667 ln ( \frac{w 4}{d} + 1.444 ) ]} , … for \cdot \frac{w 4}{d} \geq 1 & ( 1 ) \\ {ɛ}_{r , eff} = \frac{{ɛ}_{r} + 1}{2} + \frac{{ɛ}_{r} - 1}{2} \cdot \frac{1}{\sqrt{1 + 12 d / w 4}} & ( 2 )\end{matrix}$$

The effective dielectric constant ∈_{r,eff} can be interpreted as the dielectric constant of a homogeneous medium that replaces the air above the conductor of width w4.

### CPWG:

After the microstrip line there is a transition to a structure with a geometry that is a variation of a CPWG. In the invention there is a galvanic connection from the first ground portion 24 and the second ground portion 27 to the third ground plane 19 via the connectors 25 and 28, respectively. In the classical CPWG structure the grounding of 24 and 27 is arranged by other means. Above the CPWG-structure, the filter unit 1 is mounted. Such a stacked structure does, to our best of knowledge, have not yet any closed form expressions for the resulting geometries of conductor widths and gaps that will give a desired characteristic impedance Z0, say close to 50 Ohm.

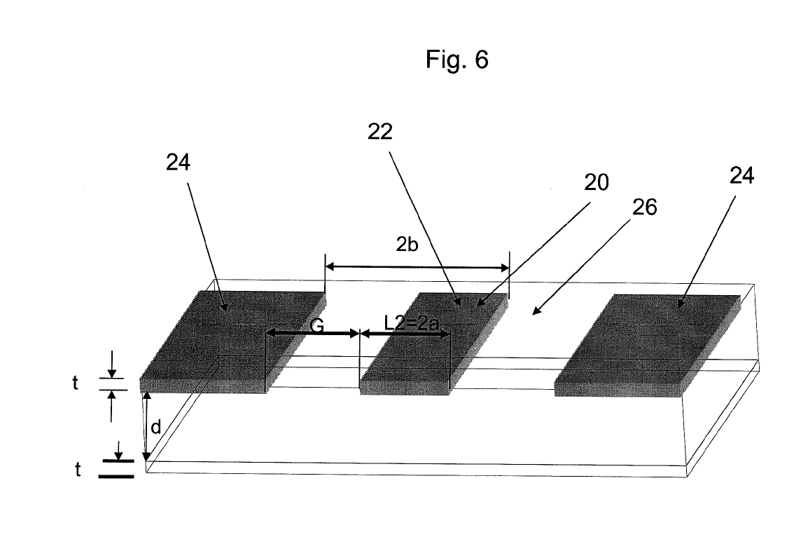

However, the CPWG structure have been analyzed separately as a stand alone structure. The expressions for Z₀ and ∈_{r,eff} are given below, assuming G=G1=G2, 2b=2a+G and W5=2a, dielectric constant ∈ᵣ and a substrate thickness d, see FIGS. 3b and 6

$$\begin{matrix}{Z}_{0} = \frac{60 π}{\sqrt{{ɛ}_{r , eff}}} \frac{1}{\frac{K ( k )}{K ( {k}^{′} )} + \frac{K ( {k}_{3} )}{K ( {k}_{3}^{′} )}} & ( 3 ) \\ {ɛ}_{r , eff} = \frac{1 + {ɛ}_{r} \frac{K ( {k}^{′} )}{K ( k )} \frac{K ( {k}_{3} )}{K ( {k}_{3}^{′} )}}{1 + \frac{K ( {k}^{′} )}{K ( k )} \frac{K ( {k}_{3} )}{K ( {k}_{3}^{′} )}} \\ where & ( 4 ) \\ k = a / b = \frac{1}{1 + \frac{G}{L 2}} \\ {k}_{3} = tanh ( π a / 2 d ) / tanh ( π b / 2 d ) \\ {k}^{′} = \sqrt{1.0 - {k}^{2}} \\ {k}_{3}^{′} = \sqrt{1.0 - {k}_{3}^{2}} \\ 2 a = L 2 \\ 2 b = G + L 2 & ( 5 )\end{matrix}$$

and K(k) is the complete elliptic integral of the first kind.

With reference to FIGS. 1, 2, 3a, 5a and 5b: Stripline is a planar-type of transmission line that lends itself to microwave design. The geometry of a stripline consists of a thin conducting strip of width w8 and thickness t4, and is centred between two wide conducting ground planes, defining the boundary of a dielectric substrate of thickness b with a dielectric constant ∈ᵣ.

The expression for the characteristic impedance Z0 is

$$\begin{matrix}{Z}_{0} = \frac{30 π}{\sqrt{{ɛ}_{r}} ( \frac{w 8 / b}{1 - t 4 / b} + \frac{{C}_{f}}{0.885 {ɛ}_{r}} )} where & ( 6 ) \\ {C}_{f} = \frac{0.855 {ɛ}_{r}}{π} ( \frac{2}{1 - t 4 / b} ln ( \frac{1}{1 - t 4 / b} + 1 ) - ( \frac{1}{1 - t 4 / b} - 1 ) ln ( \frac{1}{{( 1 - t 4 / b )}^{2}} 1 ) ) & ( 7 )\end{matrix}$$

Equations (6) and (7) are valid for w8/(b−t4)≧0.35, with a maximum error of 1.2% at the lower limit of w8.

The first and second ground portions 24, 27 have a thickness t3 that corresponds to the thickness t1 of the second conductor structure 20 in such a way that the second ground portions 24, 27 can be in galvanic contact with the second ground plane 4 when assembled. The third and fourth end portions 22, 23 also have a thickness that allows for the second ground plane 4 of the filter unit 1 to be attached to the ground portions 24, 27 and at the same time for the first and second connector pads 15, 16 to be galvanic connected to the third and fourth end portions 22, 23 respectively.

For the same reasons, the second ground plane 4 have a thickness t2 that correspond to the thickness of the first and second connector pads 15, 16.

A numerical example of the invention will now be described with reference to FIGS. 4b and 5b. The example has experimentally been proven to show good results for characteristic impedance Z0 close to 50 ohm with very low signal losses. This example is valid for both ends of the filter unit and both ends of corresponding portions of the printed circuit board described in connection to FIGS. 1-6.

FIG. 4b shows a detailed top view of the layout of the PCB 2. In FIG. 4b, the first ground portion 24 is shown together with the second conductor structure 20. The plated via holes connecting the first ground portion to the third ground plane 19 are shown by dashed circles. The second ground portion 27 is constructed in the same way as the first ground portion, and with the same dimensions.

The length of the first ground portion 24 in the x-direction, called L₁, is in our example 3 mm. The minimum width of the first ground portion, W₁, is 5 mm. The width of the ground portion can be made greater to match the filter that is needed. The diameter of each plated via hole is 0.3 mm. The second conductor structure 20 is the structure that guides the signal from the PCB into the microstrip to stripline transition. Depending on the dielectric constant and the thickness of the substrate 21, the width of this conductor is chosen so to create the characteristic impedance that is desired. In our example the thickness d of the second substrate 21 is 0.254 mm and the dielectric constant ∈ᵣ is 3.66, which gives the width W₄=0.524 mm.

In the first ground portion is cut a notch 14. Into this notch the second conductor structure 20 is laid out. The conductor 20 is centred in the slot making the gaps G₁ and G₂ equal in size, however this is not strictly necessary if for some purpose one would like to have an asymmetric structure. The second conductor structure, which creates an end portion labelled the third end portion 22, has a width W₅ (in our example 0.4 mm). This width can be chosen in a certain range depending on the size of the gap G₁ and G₂ (which in our example is 0.22 mm). The width W₅ and the gap size G₁=G₂ are chosen as to (together with the thickness and the dielectric constant of the second substrate 21) create a coplanar waveguide structure with a certain specified characteristic impedance (in our example this impedance is 50Ω).

In order to reduce unwanted coupling from the second conductor 20 to the first ground portion 24, the corners of the first ground portion are cut at a 45° angle (giving that the lengths L₆ and W₆ are equal). This angle is not specifically important and can be chosen in a certain range if some other angle is more convenient. The size of the cut corner W₆ can be chosen in a range of values (in our example it is 0.55 mm). The length of the transition of the second conductor structure 20 from width W₄ to width W₅ should not be too short (to reduce the impedance mismatch) and is in our example chosen to be 0.3 mm.

As discussed above, the third end portion together with the first ground portion creates a coplanar waveguide structure. The dimensions of this waveguide structure are chosen in order to create a specific characteristic impedance (in our specific example chosen to be 50Ω). Depending on the dimensions of the width W₅ of the third end portion 22 and the gap size G₁=G₂ the width of the third notch 26 will have a certain value (in our example 0.84 mm). The length of the third notch 26 should be chosen in conjunction with the length of the third end portion to create a smooth transition from microstrip mode to coplanar waveguide mode for the microwave signal. A trade-off must be made between the length L₁ of the microstrip to stripline transition and the performance of the transition. In our case it is seen that a length L₁ of 3 mm is sufficient to give good performance.

The third end portion ends in a semi-circle (for convenience chosen to have a radius R₁ equal to 0.2 mm). The end of the third notch 26 also ends in a semi-circle (for convenience chosen to have a radius R₂ equal to 0.42 mm in our example). The length of the third end portion L₃ is in our example 1 mm. The length of the third notch L₇ is in our example 1.25 mm. The length of the gap L₄ between the third end portion and the first ground portion is in our example 0.82 mm. This length can be chosen in a certain range to achieve desired performance.

The spacing S₁ between the centre line of the transition and the plated via holes connecting the first ground portion to the third ground plane 19 should not be too small. Otherwise this would interfere with the microstrip mode of the second conductor structure. In our example this length has been chosen to be 1.25 mm. The distance between the edges of the first ground portion and the centre of the closest via holes S₂ and S₃ can be different (for convenience it is chosen to be equal to 0.55 mm for both S₂ and S₃ in our example). The separation between the centres of the via holes S₄ and S₅ can also be chosen to be different (in our example they are equal and of size 0.7 mm). All spacings between the via holes are of less importance and can be chosen rather freely.

FIG. 5b shows a detailed bottom view of the second ground plane 4. Note that it is only the part of the ground plane around the first microstrip to stripline transition that is shown. The part of the ground plane around the second transition is designed in the same way. A view of the whole ground plane is shown in FIG. 5a.

In FIG. 5b is shown the second ground plane 4, the first connector pad 15, and the first notch 13. Shown by dashed lines are also the third connectors 12 (connecting the first ground plane 3 to the second ground plane 4), the first connector 10 (connecting the first connector pad to the first end portion 7 of the first conductor structure 6), and the first end portion 7 of the first conductor structure 6.

In FIG. 5b, the diameters of the third connectors are all equal to 0.3 mm. The diameter of the first connector 10 is also 0.3 mm. The spacing between the third connectors (S₄ and S₅ are the same as in FIG. 4b and is 0.7 mm). The distances between the third connectors and the edge of the second ground plane S₆ and S₇ are both equal to 0.35 mm.

The length L₈ and the width W₇ of the transition part of the second ground plane is 2.8 mm and 4.6 mm, respectively. The width of the first connector pad W₅ 0.4 mm (as in FIG. 4b). The lengths W₂, W₃, G₁, G₂, L₅, L₃, R₁, R₂, S₁, and L₇ are also the same as in FIG. 4b.

The lengths of the cut corners of the second ground plane L₉ and W₉ are both equal to 0.35 mm.

The width W₈ of the first end portion 7 of the first conductor structure 6 is chosen to result in a specific impedance of the stripline transmission line. Given that the thickness b of the first dielectric substrate 5 is in the range of 1.5 to 1.6 mm and the dielectric constant ∈ᵣ is 3.66 in our example, this gives a width W₈ of 0.8 mm for a 50Ω impedance. The radius of the end of the first end portion is 0.4 mm.

The first ground portion 24 and the second ground portion 27 are designed to match the second ground plane 4. The dimensions of the first and second ground portions are however made 0.2 mm larger so that the soldering of the filter unit 1 to the printed circuit board 2 will be open for inspection.

With reference to FIGS. 1-6 it should be clear for a person skilled in the art that not only the described examples are part of the invention, but that additional arrangements of the first and second ground portions 24, 27 can be contemplated as long as the predetermined impedance matching is met. For example, the first and second ground portions may extend over the entire filter unit area as long as the above described.

The invention is not limited to the embodiments and examples described above, but may vary freely within the scope of the amended claims.

1. A stripline microwave filter unit for a printed circuit board, the filter unit comprising a layered structure comprising:
a first ground plane,
a second ground plan,
a dielectric first substrate between the first ground plane and the second ground plane,
a first conductor structure embedded in the first substrate, the first conductor structure having a first end portion and a second end portion,
a first connector configured to connect the first end portion to a bottom outside of the filter unit,
a second connector configured to connect the second end portion to the bottom outside of the filter unit,
a third connector configured to connect the first ground plane to the second ground plane,
wherein the second ground plane is positioned on the bottom outside of the filter unit, wherein the second ground plane has a first notch in connection to the first connector revealing the first substrate, wherein the second ground plane has a second notch in connection to the second connector revealing the first substrate,
a first connector pad positioned in the first notch on the bottom outside of the first substrate, the first connector pad being connected to the first connector, and
a second connector pad positioned in the second notch on the bottom of the outside of the first substrate, the second connector pad being connected to the second connector,
wherein the third connector comprises fourth connectors electromagnetically coupled to the first connector and fifth connectors electromagnetically coupled to the second connector, wherein the first end portion, the first connector, the first connector pad, the fourth connectors and the first notch are positioned in relation to each other such that a predetermined impedance is essentially obtained for the transmission of a signal from the first connector pad to the first end portion, and wherein the second end portion, the second connector, the second connector pad, the fifth connectors and the second notch are positioned in relation to each other such that a predetermined impedance is essentially obtained for the transmission of a signal from the second end portion to the second connector pad.

2. The filter unit according to claim 1, wherein the first ground plane, the second ground plane, the first conductor structure, the first end portion, the second end portion, the bottom outside, the first connector, the second end portion, the second connector, the third connector, the first connector pad, the second connector pad, the fourth connectors and the fifth connectors are made of electrically conducting materials.

3. The filter unit according to claim 1, wherein the first conductor structure comprises a flat strip of metal which is embedded in the dielectric first substrate and sandwiched between the first ground plane and a second ground plane being parallel to each other.

4. The filter unit according to claim 1, wherein first conductor structure comprises a number of strips being electromagnetically connected, wherein the interrelationship between these parts forms the filter characteristics.

5. The filter unit according to claim 1, wherein the first conductor structure is equally spaced between the ground planes or the dielectric first substrate has different characteristics and thickness above and below the first conductive structure.

6. A printed circuit board, comprising:
a microstrip structure for a filter unit the microstrip structure comprising a layered structure comprising:
a first ground plane,
a second ground plane,
a dielectric first substrate between the first ground plane and the second ground plane,
a first conductor structure embedded in the first substrate, the first conductor structure having a first end portion and a second end portion,
a first connector configured to connect the first end portion to a bottom outside of the filter unit,
a second connector configured to connect the second end portion to the bottom outside of the filter unit,
a third connector configured to connect the first ground plane to the second ground plane,
wherein the second ground plane is positioned on the bottom outside of the filter unit, wherein the second ground plane has a first notch in connection to the first connector revealing the first substrate, wherein the second ground plane has a second notch in connection to the second connector revealing the first substrate,
a first connector pad positioned in the first notch on the bottom outside of the first substrate, the first connector pad being connected to the first connector, and
a second connector pad positioned in the second notch on the bottom of the outside of the first substrate, the second connector pad being connected to the second connector,
wherein the third connector comprises fourth connectors electromagnetically coupled to the first connector and fifth connectors electromagnetically coupled to the second connector, wherein the first end portion, the first connector, the first connector pad, the fourth connectors and the first notch are positioned in relation to each other such that a predetermined impedance is essentially obtained for the transmission of a signal from the first connector pad to the first end portion, and wherein the second end portion, the second connector, the second connector pad, the fifth connectors and the second notch are positioned in relation to each other such that a predetermined impedance is essentially obtained for the transmission of a signal from the second end portion to the second connector pad,
a third ground plane,
a second conductor structure, and
a dielectric second substrate between the third ground plane and the second conductor structure,
wherein the second conductor structure comprises a third end portion and a fourth end portion, wherein the third end portion and the fourth end portion are positioned relative each other such that the first connector pad of the filter unit can be attached to the third end portion and such that the second connector pad can be attached to the fourth end portion,
a first ground portion positioned on the same side of the second substrate as the second conductor structure,
a first ground connector configured to connect the first ground portion to the third ground plane,
wherein the first ground portion comprises a third notch positioned such that the third end portion is positioned within the third notch,
a second ground portion positioned on a same side of the second substrate as the second conductor structure,
a second ground connector configured to connect the second ground portion to the third ground plan,
wherein the second ground portion comprises a fourth notch positioned such that the fourth end portion is positioned within the fourth notch, wherein the first ground portion and the second ground portion can be galvanic connected to the second ground plane of the filter unit; and wherein the first ground portion, the third notch, the third end portion and the first ground connector are positioned in relation to each other such that a predetermined impedance is essentially obtained in the third end portion for the transmission of a signal from the second conductor structure to the filter unit, and wherein the second ground portion, the fourth notch, the fourth end portion and the second ground connector are positioned in relation to each other such that a predetermined impedance is essentially obtained in the fourth end portion for the transmission of a signal from the filter unit to the second conductor structure.

7. The printed circuit board according to claim 6, wherein the third ground plane, the second conductor structure, the dielectric second substrate, the third end portion, the fourth end portion, the first ground portion, the first ground connector, the second ground portion and the second ground connector are made of electrically conducting materials.

8. The printed according to claim 6, wherein the first and second ground portions are part of the printed circuit board.

9. The printed according to claim 6, wherein a support portion is positioned between the first ground portion and the second ground portion for support of the filter unit on the printed circuit board.

10. The printed according to claim 9, wherein the support portion is connected to the third ground plane via connectors for additional conduction between the third ground plane and the filter unit via galvanic contact with the second ground plane.

11. A device, comprising:
a stripline microwave filter unit comprising a layered structure comprising:
a first ground plane,
a second ground plane,
a dielectric first substrate between the first ground plane and the second ground plane,
a first conductor structure embedded in the first substrate, the first conductor structure having a first end portion and a second end portion,
a first connector configured to connect the first end portion to a bottom outside of the filter unit,
a second connector configured to connect the second end portion to the bottom outside of the filter unit,
a third connector configured to connect the first ground plane to the second ground plane,
wherein the second ground plane is positioned on the bottom outside of the filter unit, wherein the second ground plane has a first notch in connection to the first connector revealing the first substrate, wherein the second ground plane has a second notch in connection to the second connector revealing the first substrate,
a first connector pad positioned in the first notch on the bottom outside of the first substrate, the first connector pad being connected to the first connector, and
a second connector pad positioned in the second notch on the bottom of the outside of the first substrate, the second connector pad being connected to the second connector,
wherein the third connector comprises fourth connectors electromagnetically coupled to the first connector and fifth connectors electromagnetically coupled to the second connector, wherein the first end portion, the first connector, the first connector pad, the fourth connectors and the first notch are positioned in relation to each other such that a predetermined impedance is essentially obtained for the transmission of a signal from the first connector pad to the first end portion, and wherein the second end portion, the second connector, the second connector pad, the fifth connectors and the second notch are positioned in relation to each other such that a predetermined impedance is essentially obtained for the transmission of a signal from the second end portion to the second connector pad, and
a printed circuit board, comprising
a third ground plane,
a second conductor structure,
a dielectric second substrate between the third ground plane and the second conductor structure,
wherein the second conductor structure comprises a third end portion and a fourth end portion, wherein the third end portion and the fourth end portion are positioned relative each other such that the first connector pad of the filter unit can be attached to the third end portion and such that the second connector pad can be attached to the fourth end portion,
a first ground portion positioned on the same side of the second substrate as the second conductor structure,
a first ground connector configured to connect the first ground portion to the third ground plane,
wherein the first ground portion comprises a third notch positioned such that the third end portion is positioned within the third notch,
a second ground portion positioned on a same side of the second substrate as the second conductor structure,
a second ground connector configured to connect the second ground portion to the third ground plane,
wherein the second ground portion comprises a fourth notch positioned such that the fourth end portion is positioned within the fourth notch, wherein the first ground portion and the second ground portion can be galvanic connected to the second ground plane of the filter unit; and wherein the first ground portion, the third notch, the third end portion and the first ground connector are positioned in relation to each other such that a predetermined impedance is essentially obtained in the third end portion for the transmission of a signal from the second conductor structure to the filter unit, and wherein the second ground portion, the fourth notch, the fourth end portion and the second ground connector are positioned in relation to each other such that a predetermined impedance is essentially obtained in the fourth end portion for the transmission of a signal from the filter unit to the second conductor structure,
wherein when the filter unit is attached to the printed circuit board, the first ground portion and the second ground portion are galvanically connected to the second ground plane of the filter unit and the first connector pad of the filter unit is galvanic connected to the third end portion and the second connector pad is galvanic connected to the fourth end portion.
